(19) United States
(12) Patent Application Publication
(10) Pub. No.: US 2018/0176672 A1
(43) Pub. Date: Jun. 21, 2018

(54) Automatic Noise Cancelling Earbuds

(71) Applicant: Matthew Robert Adkins, Oak Harbor, OH (US)

(72) Inventor: Matthew Robert Adkins, Oak Harbor, OH (US)

(21) Appl. No.: 15/382,714

(22) Filed: Dec. 18, 2016

(51) Int. Cl. H04R 1/10

(52) U.S. Cl. CPC H04R 1/1016; H04R 1/1025; H04R 1/1033; H04R 2420/09; H04R 2460/01; H04R 2420/07

(57) ABSTRACT

The current invention are earbuds that are wireless capable, allowing wireless play from wireless-capable devices. These earbuds have automatic noise-cancelling. This noise-cancelling will activate when environmental noise reaches a certain decibel level, but won't cancel lower, normal daily levels of noise. The earbuds have additional features, such as a detachable retaining cord and USB port. The USB port allows charging, and can be used for wired play through USB enabled devices that aren't wireless capable. The low profile of these earbuds would allow a sleek everyday look, while the retaining cord and automated noise-cancelling function make this device suitable for noisy workplaces.

### CROSS-REFERENCE TO RELATED APPLICATIONS (IF ANY)

None.

### BACKGROUND

### 1. Field of the Invention

This invention relates to earbuds with an automatic noise cancelling feature.

### 2. Description of Prior Art

There is a need for workers and people to cover a workers ears when the sounds of machinery such as a band saw, lathe etc are nearby to prevent ear damage and the annoyance. One trend is the emergence of fashion-driven bulky over-ear headphones. These are bulky and can be distracting and there by dangerous.

There is still room for improvement in the art.

### SUMMARY OF THE INVENTION

The current invention are wireless earbuds that have automated noise cancelling in high noise environments. The earbuds have an optional wire to link them, and USB ports to allow possible charging or storage options.

Each earbud is comprised of an antenna, a main board, a two-battery power supply, speaker membrane and mesh grille, USB receiver, and an external switch. On the outside shell of the earbud, there is a port to attach a retaining cord to connect the two earbuds, to prevent losing one if it fell out of the user's ear.

The mainboard would process external noise input and initiate noise cancelling.

The earbuds are currently designed with a black outer housing, while tips may be of various colors. Both the housing and the tips could be produced in a single color offering or in many options.

### BRIEF DESCRIPTION OF THE DRAWINGS

Without restricting the full scope of this invention, the preferred form of this invention is illustrated in the following drawings:

FIG. 1 shows the side view of a pair of earbuds with optional retaining cord;

FIG. 2 shows a closer side view of a pair of earbuds with optional retaining cord;

FIG. 3 shows earbuds showing the rear switch and USB port; and a cross cut view;

FIG. 4 shows the earbuds with optional retaining cord from a front view;

FIG. 5 shows a perspective rear view;

FIG. 6 shows a frontal angle cutaway of an earbud without a tip;

FIG. 7 shows a cross cut view of the internal composition of an earbud; and

FIG. 8 shows a cutaway view of an earbuds.

### DESCRIPTION OF THE PREFERRED EMBODIMENT

There are a number of significant design features and improvements incorporated within the invention.

The current invention are wireless earbuds 1 that have automated noise cancelling in high noise environments. The earbuds 1 have an optional wire 10 to link them, and USB ports 100 to allow possible charging or storage options.

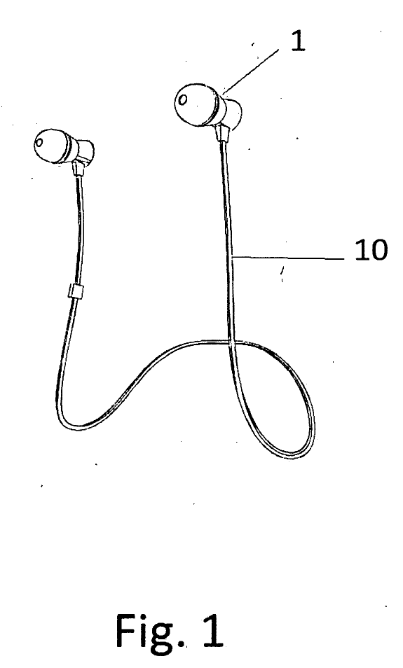

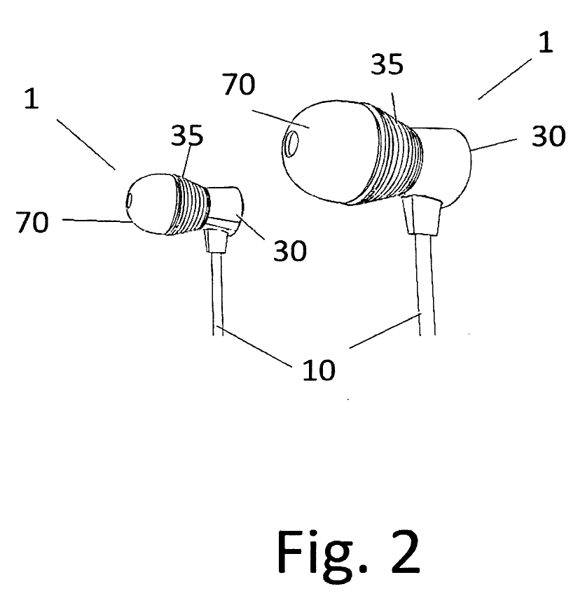

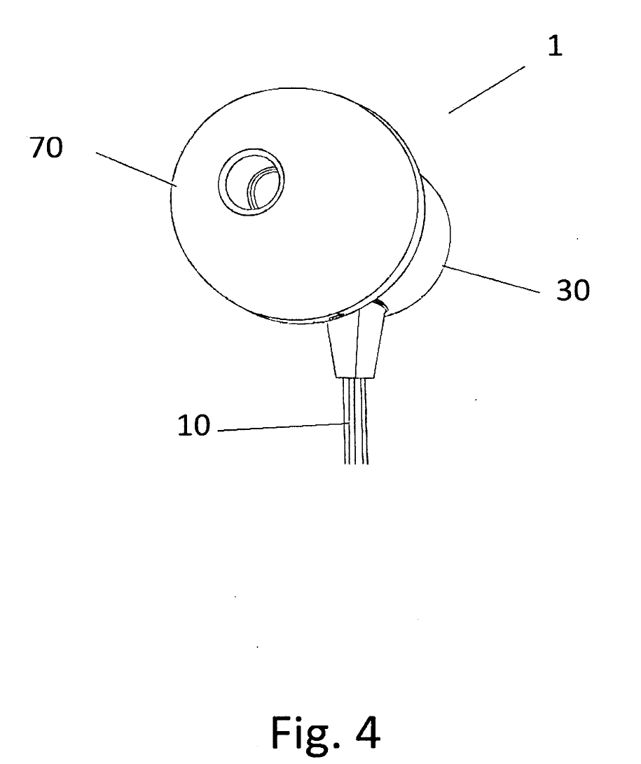

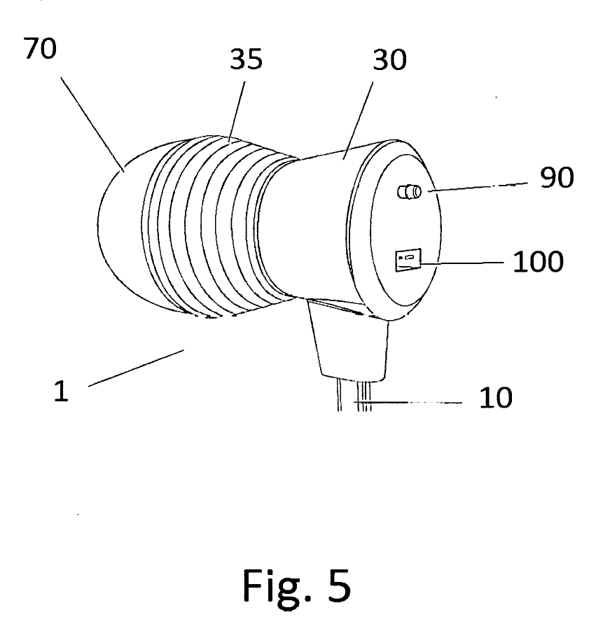

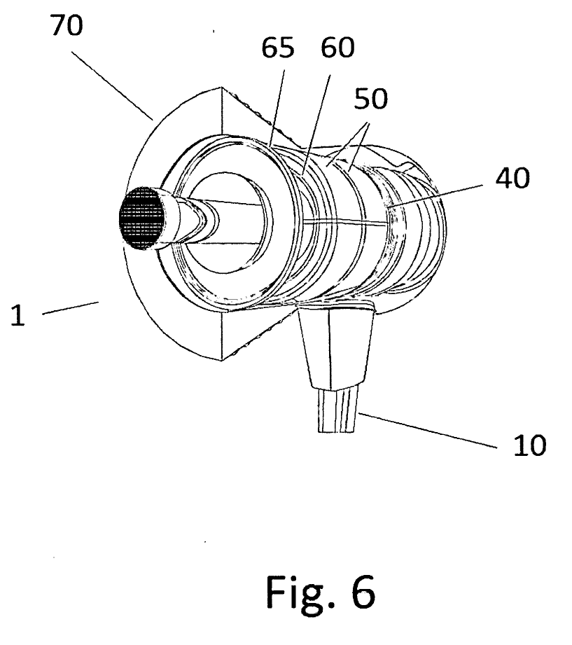

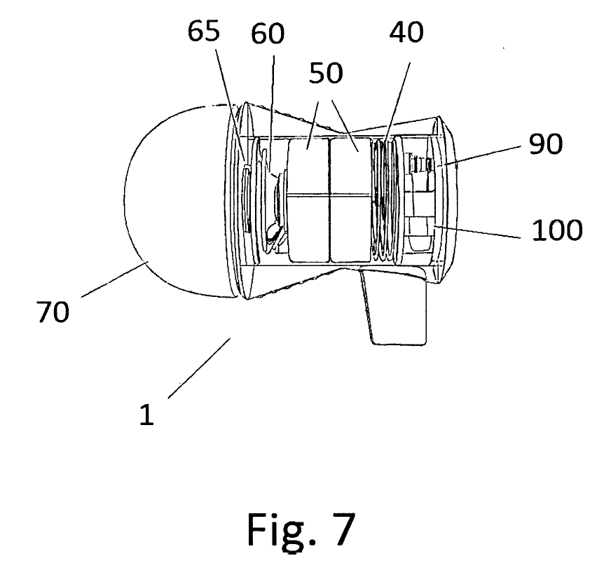

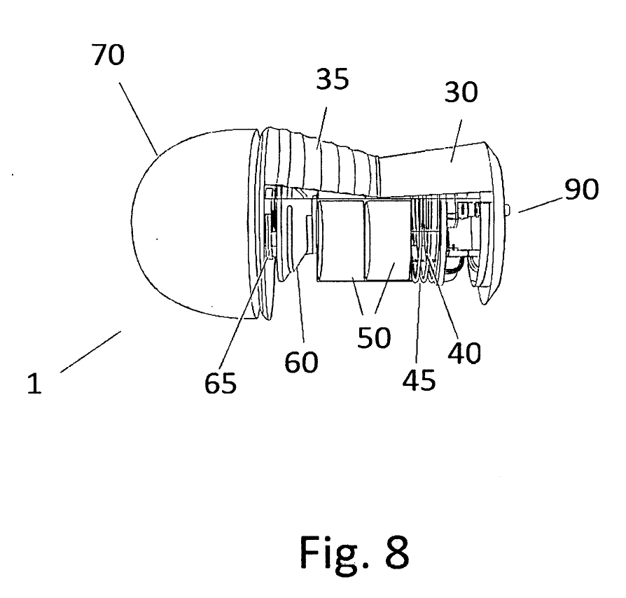

The earbuds 1, as shown in FIGS. 1-8, allows a user to listen to music, wire free, in any environment. The earbuds 1 have sound detection technology and software that stops disruptions and distracting noise.

The earbuds 1 have an outer housing which is made of a plastic and can be any color. The housing is comprised of an ear piece 70, outer shell 35 and base 30. The base 30 is cylindrical in shape. The outer shell 35 flares out from the base 30 to the ear piece 70. The ear piece 70 is on the front of the housing while the base 30 is on the back. The ear piece 70 has a hole for the sound.

Each earbud 1 is comprised of an antenna 45, a main board 40, a two-battery power supply 50, speaker membrane 60 and mesh grille 65, USB receiver 100, and an external switch 90. On the outside shell of the earbud, there is a port to attach a retaining cord 10 to connect the two earbuds 1, to prevent losing one if it fell out of the user's ear.

The antenna 45 is connected to the main board 40 which is connected to the two-battery power supply 50 and connected to the speaker membrane 60. The antenna 45, main board 40, power supply 50, speaker membrane 60 and mesh grill 65 are contained within the housing. The speaker membrane 60 and mesh grill 65 are on the front end of the housing so that the sound goes out of a hole in the ear piece 70.

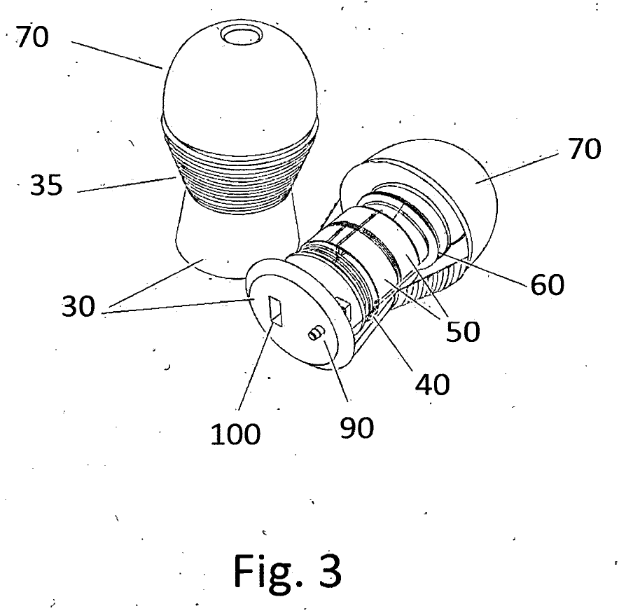

The USB port 100 can be used to provide power or data to the earbuds 1. The USB port 100 is in the back of the base 10 in the preferred embodiment. The external switch 90 will also be on the back of the base 10 in the preferred embodiment as shown in FIG. 3. The external switch 90 will turn the earbuds 1 on or off.

The mainboard 40 would receive music or audio files through the antenna 45. This would be through Bluetooth in the preferred embodiment. The mainboard 40 would play the music or audio files through the speaker membrane 60.

The mainboard 40 would have a processing unit or microprocessor and would process external noise input and initiate noise cancelling. The mainboard 40 would have the noise cancelling programming to process the data for ‘high decibels’ to turn on noise cancelling by creating the right noise cancelling. Noise cancelling works by determining the incoming sound and creating a counter-acting soundwave. Large, over-ear headphones have space to have the requisite microphone, electronics, and speaker for noise.

Operation

The earbuds 1 would be used for listening to music via bluetooth and then the automatic noise cancel feature kicks in automatically when sound detected above a certain decibel level.

Advantages

The earbuds automatically protect a worker's ears when the sounds of machinery such as a band saw, lathe etc are nearby to prevent ear damage and the annoyance.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
earbuds having a mainboard connected to a speaker membrane having noise cancelling.

2. A device according to claim 1 comprising:
Having the noise cancelling triggered by a set decibel level.

3. A device according to claim 1 comprising:
Having a battery source.

4. A device according to claim 1 comprising:
Having a wire connected to the earbuds.

5. A device according to claim 1 comprising:
Having a USB port.

6. A device according to claim 1 comprising:
Where said earbuds have an outer housing.

7. A device according to claim 1 comprising:
Where the housing is comprised of an ear piece, outer shell and base.

8. A device according to claim 1 comprising:
Where the ear piece has a hole.

9. A device according to claim 1 comprising:
Having an external switch.

10. A device according to claim 7 comprising:
Having an external switch on said base.

11. A device according to claim 10 comprising:
Where said external switch turns the earbuds on or off

12. A device according to claim 1 comprising:
Having a mesh grille attached to said speaker membrane.

13. A device comprising:
earbuds having a mainboard having a battery source connected to a speaker membrane having noise cancelling where said earbuds have an outer housing.

14. A device according to claim 1 comprising:
Having the noise cancelling triggered by a set decibel level.

15. A device according to claim 1 comprising:
Having a wire connected to the earbuds.

16. A device according to claim 1 comprising:
Having a USB port.

17. A device according to claim 1 comprising:
Where the housing is comprised of an ear piece with a hole, outer shell and base.

18. A device according to claim 1 comprising:
Having an external switch that turns the earbuds on or off.

19. A device according to claim 1 comprising:
Having a mesh grille attached to said speaker membrane.

20. A device according to claim 1 comprising:
Where said mainboard has a processing unit.
